(19) United States
(12) Patent Application Publication
(10) Pub. No.: US 2026/0085617 A1
(43) Pub. Date: Mar. 26, 2026

(54) RECIRCULATOR CASING TREATMENT FOR GAS TURBINE ENGINES

(71) Applicant: Pratt & Whitney Canada Corp., Longueuil (CA)

(72) Inventors: Matheson West, London (CA); Venkata Mahankali, Longueuil (CA)

(21) Appl. No.: 18/897,069

(22) Filed: Sep. 26, 2024

(51) Int. Cl. F01D 11/04; F04D 17/10; F04D 29/42

(52) U.S. Cl. CPC F01D 11/04; F04D 17/10; F04D 29/4206; F05D 2220/32; F05D 2240/14; F05D 2240/55

(57) ABSTRACT

Centrifugal compressors for gas turbine engines include a casing and a rotor arranged within a casing. The rotor includes a hub and blades. Each blade extends from an inlet to an outlet of the compressor. A casing treatment is applied to the casing that includes a set of recirculators that each define a recirculator passage that extends from a passage inlet to a passage outlet. A recirculation flow through the recirculators is in a recirculation flow direction counter to a main flow direction. An inlet of each recirculator is at a position downstream relative to a respective outlet of the same recirculator and each inlet and outlet has a dimension in a main flow direction defined based on a relationship relative to a leading edge span of the blades.

### BACKGROUND

The subject matter disclosed herein generally relates to gas turbine engines and, more particularly, to casing treatments of gas turbine engines.

A limiting factor in gas turbine engine performance may be related to the stability of the compression system. In that regard, greater stability in the compression system supports improved engine operation. The stability of the compression system in a gas turbine engine may be limited by both the engine operating conditions and stall capability of the compressor. In some compressors, the initiation of a stall may be driven by tip leakage flow through a tip clearance between an airfoil and an outer diameter (e.g., casing or housing) of the compressor. The detrimental characteristics of tip leakage flow may predominantly be from reverse tip leakage flow, that is, tip leakage flow moving in an aft-to-forward direction (counter to a core flow through the engine core).

Alterations to improve compressor stability by increasing the stall margin, for example, typically result in reduced engine efficiency. Casing treatments, such as geometric modifications of the walls of the compressor case, may have resulted in reduced engine efficiency at engine design conditions (e.g., cruise) in previous applications. Improved casing treatments may provide for improved engine performance.

### SUMMARY

According to some embodiments, centrifugal compressors of gas turbine engines are provided. The centrifugal compressors include a casing and a rotor arranged within the casing. The rotor includes a hub and a plurality of compressor blades extending radially from the hub and are rotatable relative to the casing. Each compressor blade of the plurality of compressor blades comprises a leading edge arranged at a compressor inlet and a trailing edge arranged at a compressor outlet. A compressor passage is defined extending from the compressor inlet to the compressor outlet. Each compressor blade has a leading edge span (S_{L}) defined as a dimension at the leading edge measured from the hub to a blade tip in a direction toward the casing. A casing treatment is applied to the casing. The casing treatment includes a set of recirculators, with each recirculator defining a recirculator passage that extends from a passage inlet to a passage outlet, and each passage inlet and each passage outlet is fluidly connected to the compressor passage. A main gas path flow through the compressor passage defines a main flow direction and a recirculation flow through the plurality of recirculators is in a recirculation flow direction, with the recirculation flow direction being counter to the main flow direction. The passage inlet of each recirculator is at a position downstream relative to a respective passage outlet of the same recirculator, and each passage inlet has a dimension in the main flow direction (W_{N}) defined by: 0.05 S_{L}≤W_{N}≤0.10 S_{L}, and wherein each passage outlet has a dimension in the main flow direction (W_{X}) defined by 0.05 S_{L}≤W_{X}≤0.10 S_{L}.

In addition to one or more of the features described herein, or as an alternative, further embodiments of the centrifugal compressors may include that each recirculator has a passage height (H_{P}) defined by 0.05 S_{L}≤H_{P}≤0.15 S_{L} wherein the passage height (H_{P}) is a distance from an interior surface of the casing to a maximum radial extent away from the interior surface.

In addition to one or more of the features described herein, or as an alternative, further embodiments of the centrifugal compressors may include that a forward end point of the passage outlet is positioned relative to a leading edge end point of the compressor blades by an offset (O_{L}) defined as −0.05 S_{L}≤O_{L}≤0.05 S_{L}.

In addition to one or more of the features described herein, or as an alternative, further embodiments of the centrifugal compressors may include that each recirculator has a contoured inlet at the passage inlet wherein an upstream edge of the passage inlet is angled in a direction toward the leading edge of the compressor blades.

In addition to one or more of the features described herein, or as an alternative, further embodiments of the centrifugal compressors may include that each recirculator has a contoured outlet at the passage outlet wherein an upstream edge of the passage outlet is angled in a direction toward the main flow direction.

In addition to one or more of the features described herein, or as an alternative, further embodiments of the centrifugal compressors may include that the set of recirculators defines a first set of recirculators and wherein the casing treatment comprises a second set of recirculators arranged downstream from the first set of recirculators.

In addition to one or more of the features described herein, or as an alternative, further embodiments of the centrifugal compressors may include that the second set of recirculators is separated from the first set of recirculators by a recirculator gap (G_{R}) defined by 0.05 S_{L}≤G_{R}≤0.10 S_{L}.

In addition to one or more of the features described herein, or as an alternative, further embodiments of the centrifugal compressors may include a third set of recirculators arranged downstream from the second set of recirculators in the main flow direction.

In addition to one or more of the features described herein, or as an alternative, further embodiments of the centrifugal compressors may include that the third set of recirculators is separated from the second set of recirculators by the recirculator gap (G_{R}).

In addition to one or more of the features described herein, or as an alternative, further embodiments of the centrifugal compressors may include that the wherein the set of recirculators defines a first set of recirculators and wherein the casing treatment comprises a second set of recirculators arranged relative to the first set of recirculators such that a passage inlet of a recirculator of the second set is arranged upstream of the passage inlet of a recirculator of the first set in the main flow direction and a passage outlet of the recirculator of the second set is arranged downstream of the passage outlet of the recirculator of the first set in the main flow direction.

In addition to one or more of the features described herein, or as an alternative, further embodiments of the centrifugal compressors may include that a passage height of each recirculator of the first set is greater than a passage height of each recirculator of the second set.

In addition to one or more of the features described herein, or as an alternative, further embodiments of the centrifugal compressors may include that the passage inlet of each recirculator is a first passage inlet, wherein each recirculators comprises a second passage inlet arranged downstream form the first passage inlet in the main flow direction.

In addition to one or more of the features described herein, or as an alternative, further embodiments of the centrifugal compressors may include that the first passage inlet and the second passage inlet fluidly connect to a single passage outlet of each recirculator.

In addition to one or more of the features described herein, or as an alternative, further embodiments of the centrifugal compressors may include that a flow from the first passage inlet and a flow from the second passage inlet are merged within a recirculator chamber prior to exiting through the single passage outlet.

In addition to one or more of the features described herein, or as an alternative, further embodiments of the centrifugal compressors may include that a direction of flow out of the compressor exit is normal to a direction of flow into the compressor inlet.

According to some embodiments, gas turbine engines are provided. The gas turbine engines include a fan, a compressor section, a combustor section, and a turbine section arranged along an engine shaft, with a core flow passing through the gas turbine engine in a core flow direction. The compressor section comprises a centrifugal compressor having a casing and a rotor arranged within the casing. The rotor includes a hub and a plurality of compressor blades extending radially from the hub and rotatable relative to the casing, and each compressor blade of the plurality of compressor blades comprises a leading edge arranged at a compressor inlet and a trailing edge arranged at a compressor outlet. A compressor passage is defined from the compressor inlet to the compressor outlet and each compressor blade has a leading edge span (S_{L}) defined as a dimension at the leading edge measured from the hub to a blade tip in a direction toward the casing. A casing treatment is applied to the casing, and the casing treatment includes a set of recirculators. Each recirculator defines a recirculator passage that extends from a passage inlet to a passage outlet, with each passage inlet and each passage outlet fluidly connected to the compressor passage. A main gas path flow through the compressor passage defines a main flow direction and a recirculation flow through the plurality of recirculators is in a recirculation flow direction, with the recirculation flow direction being counter to the main flow direction. The passage inlet of each recirculator is at a position downstream relative to a respective passage outlet of the same recirculator, and each passage inlet has a dimension in the main flow direction (W_{N}) defined by: 0.05 S_{L}≤W_{N}≤0.10 S_{L}, and wherein each passage outlet has a dimension in the main flow direction (W_{X}) defined by 0.05 S_{L}≤W_{X}≤0.10 S_{L}.

In addition to one or more of the features described herein, or as an alternative, further embodiments of the gas turbine engines may include that each recirculator has a passage height (H_{P}) defined by 0.05 S_{L}≤H_{P}≤0.15 S_{L} wherein the passage height (H_{P}) is a distance from an interior surface of the casing to a maximum radial extent away from the interior surface.

In addition to one or more of the features described herein, or as an alternative, further embodiments of the gas turbine engines may include that a forward end point of the passage outlet is positioned relative to a leading edge end point of the compressor blades by an offset (O_{L}) defined as −0.05 S_{L}≤O_{L}≤0.05 S_{L}.

In addition to one or more of the features described herein, or as an alternative, further embodiments of the gas turbine engines may include that the set of recirculators defines a first set of recirculators and wherein the casing treatment comprises a second set of recirculators arranged downstream from the first set of recirculators.

In addition to one or more of the features described herein, or as an alternative, further embodiments of the gas turbine engines may include that the second set of recirculators is separated from the first set of recirculators by a recirculator gap (G_{R}) defined by 0.05 S_{L}≤G_{R}≤0.10 S_{L}.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic cross-sectional illustration of a gas turbine engine that may incorporate embodiments of the present disclosure;

FIG. 2 is a schematic cross-sectional illustration of a turboprop engine that may incorporate embodiments of the present disclosure;

FIG. 3A is a front elevation schematic illustration of a portion of a compressor in accordance with an embodiment of the present disclosure;

FIG. 3B is a side elevation schematic illustration of the portion of the compressor of FIG. 3A;

FIG. 3C is a perspective schematic illustration of the portion of the compressor of FIG. 3A;

FIG. 4 is a schematic illustration of a compressor casing having a casing treatment in accordance with an embodiment of the present disclosure;

FIG. 5A is a schematic illustration of a portion of a compressor having a casing treatment in accordance with an embodiment of the present disclosure;

FIG. 5B is an enlarged illustration of a part of FIG. 5A as indicated by the dashed-line box labeled “5B”in FIG. 5A;

FIG. 5C is an enlarged illustration of a part of FIG. 5B as indicated by the dashed-line box labeled “5C” in FIG. 5B; and

FIG. 6 is a schematic illustration of a part of a compressor having a casing treatment in accordance with an embodiment of the present disclosure;

FIG. 7 is a schematic illustration of a configuration of a casing treatment in accordance with an embodiment of the present disclosure;

FIG. 8 is schematic illustration of another configuration of a casing treatment in accordance with an embodiment of the present disclosure; and

FIG. 9 is schematic illustration of another configuration of a casing treatment in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Detailed descriptions of one or more embodiments of the disclosed apparatus and/or methods are presented herein by way of exemplification and not limitation with reference to the Figures.

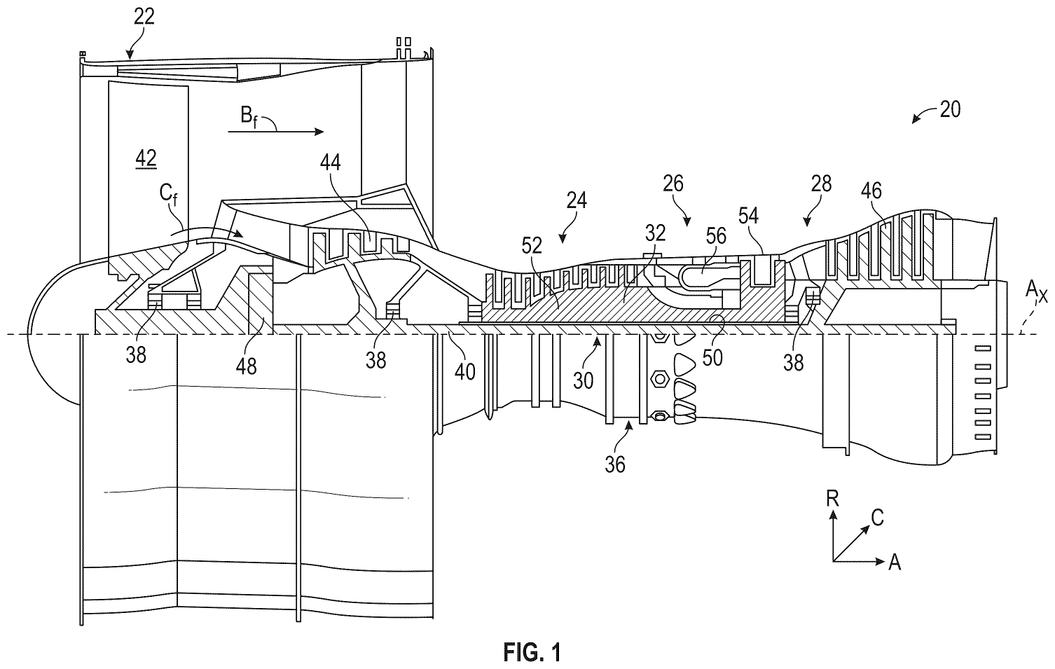

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B_{f} in a bypass duct, while the compressor section 24 drives air along a core flow path C_{f} for compression and communication into the combustor section 26 then expansion through the turbine section 28. With reference to FIG. 1, as used herein, “aft” refers to the direction associated with the tail (e.g., the back end) of an aircraft, or generally, to the direction of exhaust of the gas turbine engine (to the right in FIG. 1). The term “forward” refers to the direction associated with the nose (e.g., the front end) of an aircraft, or generally, to the direction of flight or motion (to the left in FIG. 1). An axial direction A is along an engine central longitudinal axis, referred to as engine axis Aₓ (left and right on FIG. 1). Further, radially inward refers to a negative radial direction relative to the engine axis Aₓ and radially outward refers to a positive radial direction (radial being up and down in the cross-section of the page of FIG. 1). A circumferential direction C is a direction relative to the engine axis Aₓ (e.g., a direction of rotation of components of the engine; in FIG. 1, circumferential is a direction into and out of the page, when offset from the engine axis Aₓ). An A-R-C coordinate axis is shown in FIG. 1.

The gas turbine engine 20 includes a low speed spool 30 and a high speed spool 32 mounted for rotation about the engine axis Aₓ relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44, and a low pressure turbine 46. The inner shaft 40 is connected to the fan 42 through a speed change mechanism, such as a geared architecture 48 to drive the fan 42 at a lower speed than the rotational speed of the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. An engine static structure 36 supports, for example, the bearing systems 38 in the turbine section 28. The inner shaft 40 and the outer shaft 50 are concentric and rotate via the bearing systems 38 about the engine axis Aₓ which is collinear with the longitudinal axes of the shafts 40, 50.

Core airflow is compressed by the low pressure compressor 44, then the high pressure compressor 52, mixed and burned with fuel in the combustor 56, and expanded over the high pressure turbine 54 and the low pressure turbine 46. The turbines 46, 54 rotationally drive the respective low speed spool 30 and high speed spool 32 in response to the expansion. It will be appreciated that each of the positions of the fan section 22, the compressor section 24, the combustor section 26, the turbine section 28, and the fan drive gear system 48 may be varied. For example, the gear system 48 may be located aft of the combustor section 26 or even aft of the turbine section 28, and the fan section 22 may be positioned forward or aft of the location of the gear system 48.

The gas turbine engine 20 in one non-limiting example is a high-bypass geared aircraft engine. In one such example, the bypass ratio of the gas turbine engine 20 is greater than about six (6), with an example embodiment being greater than about ten (10). The geared architecture 48 may be an epicyclic gear train, such as a planetary gear system or other gear system, with a gear reduction ratio of greater than about 2.3. The low pressure turbine 46 may have a pressure ratio that is greater than about five (5). As noted, in one disclosed embodiment, the bypass ratio of the gas turbine engine 20 may be greater than about ten (10:1). In such an example, a diameter of the fan (fan 42) may be significantly larger than that of the low pressure compressor 44. Additionally, in such an embodiment, the low pressure turbine 46 may have a pressure ratio that is greater than about five (5:1). The pressure ratio of the low pressure turbine 46 may be pressure measured prior to an inlet of the low pressure turbine 46 as related to the pressure at the outlet of the low pressure turbine 46 prior to an exhaust nozzle.

In some non-limiting embodiments, the geared architecture 48 may be an epicycle gear train, such as a planetary gear system or other gear system, with a gear reduction ratio of greater than about 2.3:1. It should be understood, however, that the above parameters are only for example purposes of a geared architecture engine and that the present disclosure is applicable to other gas turbine engines including direct drive turbofans.

A significant amount of thrust is provided by the bypass flow B_{f} due to the high bypass ratio. The fan section 22 of the gas turbine engine 20 may be designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7 °R)]^{0.5}. The “Low corrected fan tip speed” as disclosed herein according to one non-limiting embodiment is less than about 1150 ft/second (350.5 m/sec).

Although the gas turbine engine 20 is depicted as a turbofan, it should be understood that the concepts described herein are not limited to use with the described configuration, as the teachings may be applied to other types of engines such as, but not limited to, turbojets, turboshafts, etc.

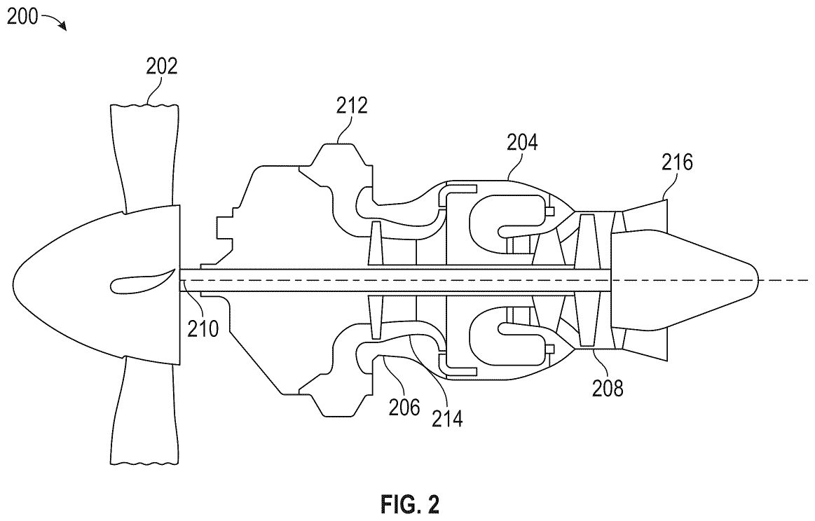

For example, referring now to FIG. 2, a schematic illustration of an aircraft engine 200 that may incorporate embodiments of the present disclosure is shown. The aircraft engine 200 includes a fan section 202, a combustion section 204, a compressor section 206, and a turbine section 208. The aircraft engine 200 may be mounted to an aircraft fuselage and operationally driven to provide propulsive or motive force for flight of the aircraft. During operation, the combustion section 204 will combust a fuel that is mixed with air. In this illustrative configuration of the aircraft engine 200, air may be compressed in the compressor section 206 and the compressed air may be then directed into the combustion section 204 for combustion with the fuel. The combusted fuel and air mixture will then be directed into and through the turbine section 208 to drive an engine shaft 210 or the like, which in turn will cause rotation of the fan section 202. The engine shaft 210 may be formed of one or more shaft sections and/or spools, as will be appreciated by those of skill in the art.

The engine shaft 210 is illustratively shown as connected to the fan section 202 of the aircraft engine 200. In some configurations, the engine shaft 210 may be directly coupled to a fan rotor or the like or may be connected thereto through a gear system, a clutch system, or the like. The engine shaft 210 defines an engine axis, engine centerline, or central axis thereof. The fan section 202, the combustion section 204, the compressor section 206, and the turbine section 208 may all be full circumference or hoop structures arranged about the engine axis, with the fan section 202 at the forward end. In this orientation, a radial direction is an outward direction from the engine axis (or engine shaft 210) and the axial direction is parallel to the direction of the engine axis.

In this engine configuration, air may enter the compressor section 206 at an air intake 212, which may be sourced from a bypass flow in a duct arranged radially outward from the air intake 212, as will be appreciated by those of skill in the art. The air is then compressed in the compressor section 206. The compressor section 206 may include an impeller or centrifugal compressor 214 that turns an axial flow to a radial flow which is then directed into a combustion chamber in the combustor section 204. The compressed air is combusted with fuel in the combustor section 204, and the hot gas output from the combustor section 204 will pass through the turbine section 208 and then be exhausted out an exhaust exit 216. The exhaust exit 216 may dump into a bypass duct of the aircraft engine 200 or may expel the combustion products out an aft end of the aircraft engine 200.

It will be appreciated that the illustrative configurations of FIGS. 1-2 are merely illustrative and provided for explanatory purposes only. Various types of compressor configurations, turbine configurations, combustor configurations and the like may be implemented on engines without departing from the scope of the present disclosure. For example, although shown in FIG. 2, with the hot gas traveling in a generally aftward direction (from the fan section 202, through the compressor section 206, the combustor section 204, and the turbine section 208), in other engine configurations, the hot gas may be directed through an impeller type compressor and then routed in an forward flowing direction such that the turbine section is forward of the combustor and the compressor is aft, as will be appreciated by those of skill in the art. The hot gas may then be directed from the turbine into a bypass flow or the like and/or exhausted out an aft end of the engine system. Furthermore, other system arrangements, such as turboshafts, turboprops, and auxiliary power units (APUs) which drive both generations and air compressors may incorporate embodiments of the present disclosure. As such, it will be appreciated that the specific illustrative configuration and arrangement of components shown in FIGS. 1-2 are merely representative and not intended to be limiting on the disclosure herein.

In operation, one limiting factor of engine performance is associated with stability of fans, rotors, turbines, compressors, etc. (i.e., rotating components) of the engines. For example, the stability of compressors in gas turbine engines may be controlled by the quality of the flow in a tip clearance region of a rotating blade. That is, as the rotating blade is rotated relative to a casing of the engine, the flow quality at the tip of the blade (e.g., between the tip of the blade and the casing) impacts engine operation, stability, and efficiency. As will be appreciated by those of skill in the art, interactions of the leakage flow and tip leakage vortex with the passage flow may generate flow blockage that is higher than design intents, and the associated instabilities can cause formation of rotating stall and surge. In some engines, casing treatments are applied to reduce the stall potential, and thus increase the stall margin of the engines. However, this increased stall margin may have a negative impact to the engine performance at high flow rates of peak engine operation (e.g., as stall margin is increased, total performance may go down).

Embodiments of the present disclosure are directed to casing treatment solutions that provide the typical benefit in terms of stall margin, while minimizing the performance impact almost entirely. In accordance with some embodiments of the present disclosure, casing treatments described herein may be applied to centrifugal compressors of turboprop engine designs (e.g., FIG. 2), but is not limited to turboprop applications, and other engine configurations (e.g., FIG. 1) may incorporate embodiments as described herein. In such configurations, the casing treatments described herein may be applied to an axial compressor. It will be appreciated that the various described configurations and features may be manufactured using known techniques, including, but not limited to, machining, casting, additive manufacturing, or the like. In embodiments that are formed using additive manufacturing techniques, the geometries and features described herein may be customizable and adaptable to specific engine configurations and applications.

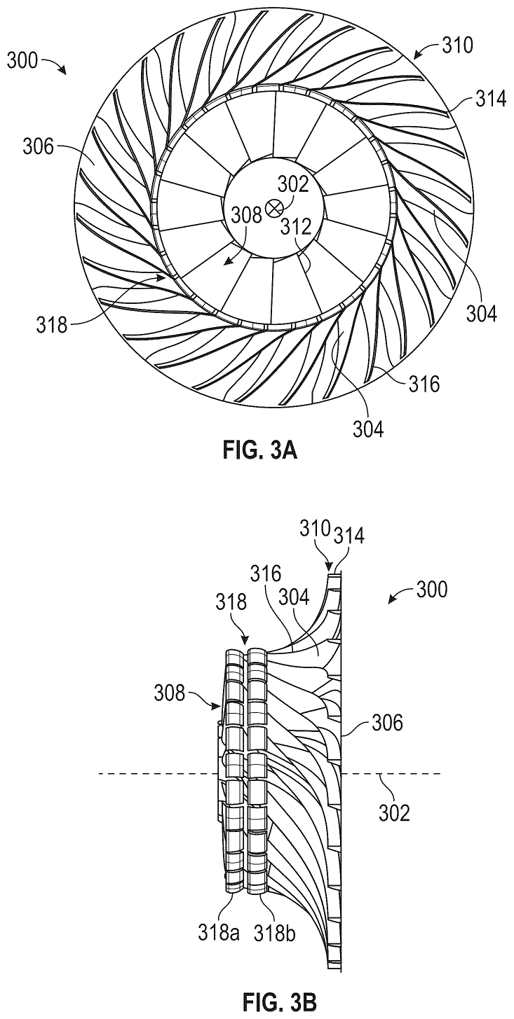

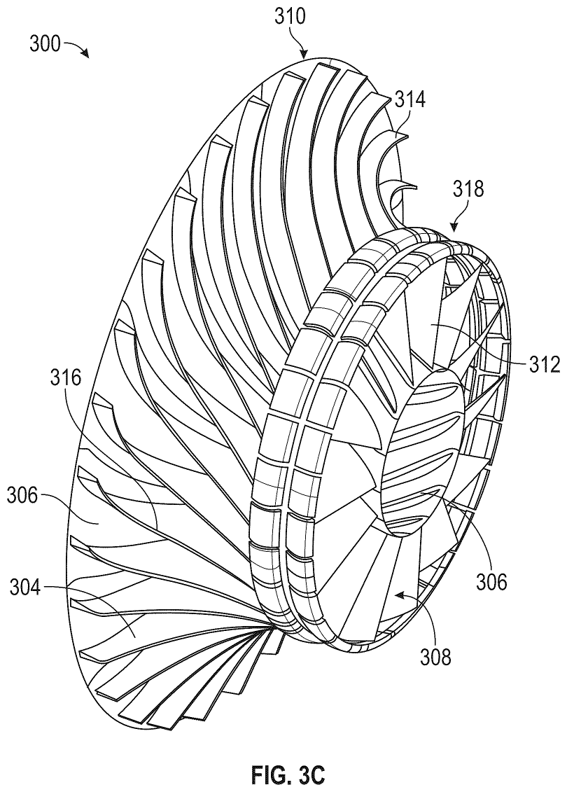

Referring now to FIGS. 3A-3C, schematic illustrations of a portion of aircraft engine compressor 300 in accordance with an embodiment of the present disclosure is shown. FIG. 3A is an elevation illustration of the compressor 300, viewed along an axis 302 through the compressor 300 (e.g., an engine axis, engine shaft axis, or the like), FIG. 3B is a side elevation view (e.g., radial view) of the compressor 300, and FIG. 3C is an isometric view thereof. The compressor 300 may be arranged relative to a casing or housing (not shown) and may be part of a gas turbine engine, such as shown and described above. In this illustrative configuration, the compressor 300 is arranged as a centrifugal compressor.

The compressor 300 includes a number of compressor blades 304 that extend axial and radially (e.g., as shown in FIG. 3B). The compressor blades 304 extend from or are mounted to a hub 306, which in this configuration is curved or arcuate, and extends from an inlet 308 to an outlet 310. Each of the compressor blades 304 has a leading edge 312 at the inlet 308 of the compressor 300 and a trailing edge 314 at the outlet 310 of the compressor 300. As illustratively shown, in the configuration of the compressor 300, the compressor blades 304 have a larger leading edge 312 as compared to the trailing edge 314. That is, the height of the compressor blades 304 from a surface of the hub 306 decreases from the inlet 308 to the outlet 310. The height of the compressor blades 304 is defined as the vertical span from the surface of the hub 306 to a blade tip 316. As shown, the blade tip 316 is also curved/arcuate and is substantially parallel with the surface of the hub 306, subject to the tapering height of the compressor blades 304.

As noted, the compressor 300 may include a housing or casing into which the hub 306 and compressor blades 304 may be installed. The hub 306 and the compressor blades 304 define the rotating components or rotor of the compressor 300, as will be appreciated by those of skill in the art. The casing defines a surface opposite the surface of the hub 306, with the compressor blades 304 arranged within a space between the surface of the hub 306 and a surface of the casing. This space is a narrowing or tapering space that tapers and reduces in height from the inlet 308 to the outlet 310 between the surface of the hub 306 and the surface of the casing. As the hub is rotated, the compressor blades 304 will rotate and air will be directed between the compressor blades 304 and compressed and turned from an axial direction along the axis 302 at the inlet 308 to a radial direction at the outlet 310.

In accordance with embodiments of the present disclosure, and as schematically shown in FIGS. 3A-3C, a casing treatment 318 may be provided proximate the blade tips 316 of the compressor blades 304. The casing treatment 318 may be defined within the structure of the casing or housing that contains the rotatory components of the compressor 300, as shown and described herein. In this schematic illustration, the casing treatment 318 is shown in isolation (i.e., without the casing illustrated). The casing treatment 318 is a set of openings and flow paths defined within the casing/housing of the compressor 300. The casing treatment 318 may be formed as a set of circumferentially located recirculator features that are arranged within the casing and proximate the blade tips 316. In this illustration, the casing treatment 318 is positioned proximate the leading edge 312 and arranged radially outward from the blade tip 316. As shown, the casing treatment 318 includes two sets of recirculators, with a first recirculator 318a arranged upstream or closer to the leading edge 312 relative to a second recirculator 318b.

In operation, as the compressor blades 304 are rotated, and the air passing through the compressor 300 is compressed and turned, a portion of the air at the blade tips 316 may enter the recirculators 318a, 318b and turned 180 degrees back in an axially forward direction (or opposite a main flow direction through the compressor 300), and then such air may be reintroduced into the flow stream at an upstream location relative to the location where the air is extracted from the flow path and enters the respective recirculators 318a, 318b. The casing treatment 318 is arranged with the recirculators 318a, 318b having a smooth profile to allow for deloading of an impeller's inducer region of the blade, while bridging a tip leakage via a channel or flow path in the casing of the compressor 300. The air is extracted at a recirculator inlet from a main gas path flow through the compressor 300 and directed to a recirculator outlet that is located upstream of the recirculator inlet (i.e., a counter flow direction to the main gas path flow). A smooth streamlined flow allows for relatively smooth circulation and can result in lower losses as compared to a non-smooth transition. The re-entry zone at the recirculator outlet allows for smooth re-entry of the air with a tangential entry angle, thus resulting in lower turbulence and losses due to different flow directions. The recirculator inlet can be configured with different angles depending on the impeller's angle of incidence at a design point. The recirculators 318a, 318b result in de-loading of the compressor blades 304, as flow is able to migrate from a pressure side of the compressor blade 304 toward a suctions side of the compressor blade 304 during conditions of large pressure differences across the compressor blades 304.

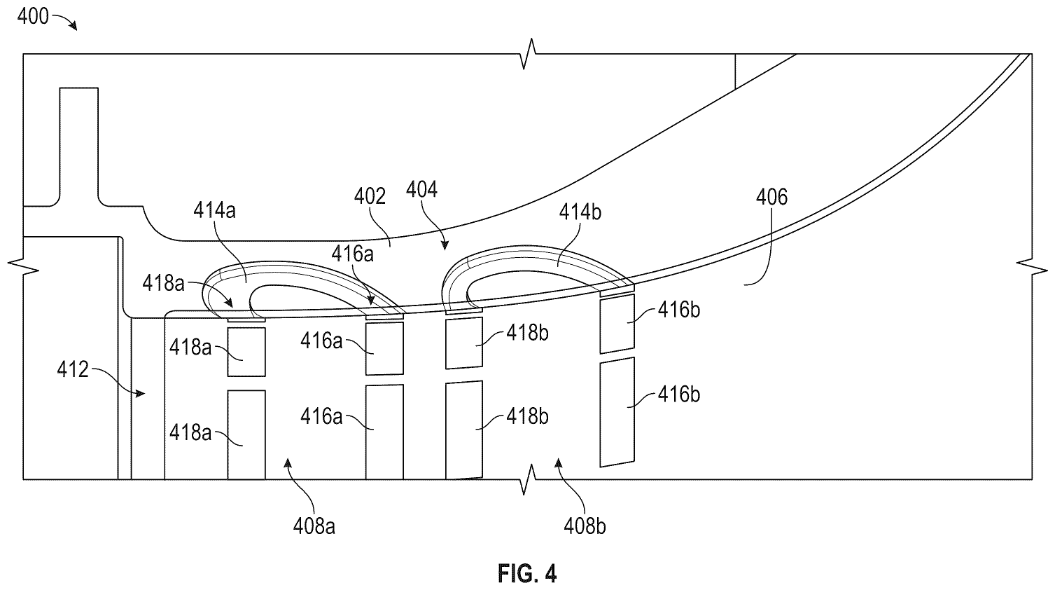

Referring to FIG. 4, a schematic illustration of a portion of a compressor 400 in accordance with an embodiment of the present disclosure is shown. The compressor 400 may be similar to that shown in FIGS. 3A-3C, although the hub and blades are not illustrated in this view for simplicity and clarity. FIG. 4 illustrates a compressor casing 402 having a casing treatment 404. The compressor casing 402 has a casing surface 406 that defines a portion of a main gas path flow passage through the compressor 400. The casing treatment 404 is defined by one or more sets of recirculators. For example, as shown in FIG. 4, a first set of recirculators 408a and a second set of recirculators 408b are arranged within the compressor casing 402. The first set of recirculators 408a are arranged proximate an inlet 412 of the compressor 400, and the second set of recirculators 408b are arranged downstream from the first set of recirculators 408a. Each set of recirculators 408a, 408b include a number of respective recirculator passages 414a, 414b that are defined within the compressor casing 402. Each recirculator passage 414a, 414b extends from a respective passage inlet 416a, 416b to a respective passage outlet 418a, 418b. The passage inlets 416a-b and the passage outlets 418a-b are openings within the casing surface 406. The recirculator passages 414a, 414b are curved or arcuate flow passages that are defined within the compressor casing 402.

It will be appreciated that the compressor casing 402 is an annular or circular structure, and the casing treatment 404 may be provided on the casing surface 406 about the full or complete circumference of the casing surface 406. As such, a rotating set of blades will pass across each of the passage inlets 416a-b and the each of the passage outlets 418a-b, as the blades are rotated within the compressor 400. As the blades travel across or past the passage inlets 416a-b, a portion of a main gas path flow that travels through the compressor 400, entering at the inlet 412 of the compressor 400, will enter the respective recirculator passages 414a, 414b. As the extracted air enters the recirculator passages 414a, 414b at the respective passage inlets 416a, 416b, the air will be turned within the recirculator passages 414a, 414b and directed in a direction counter to a direction of flow of the main gas path flow. The recirculated flow will then be reintroduced into the main gas path flow at a point upstream from where the air was extracted. That is, the recirculated flow will be reintroduced into the main gas path flow at the respective passage outlets 418a, 418b.

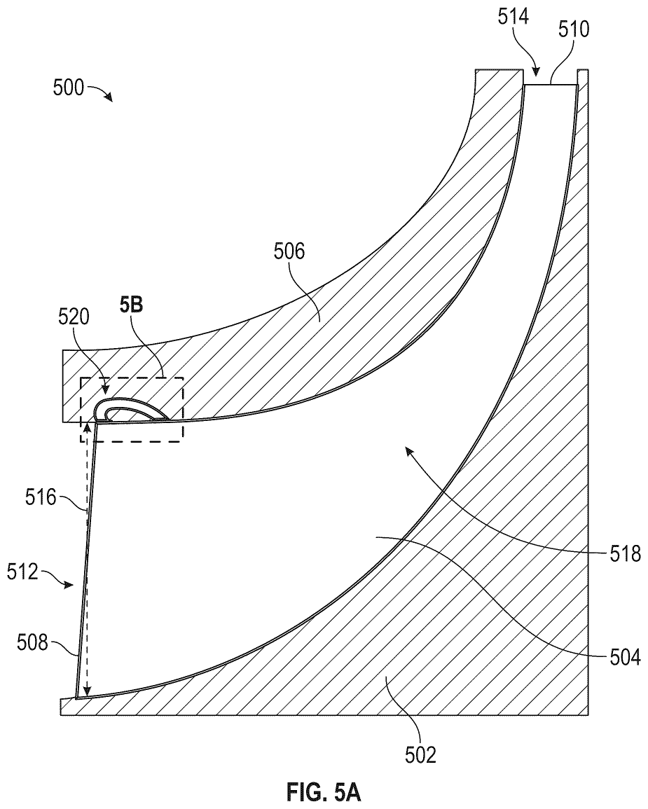

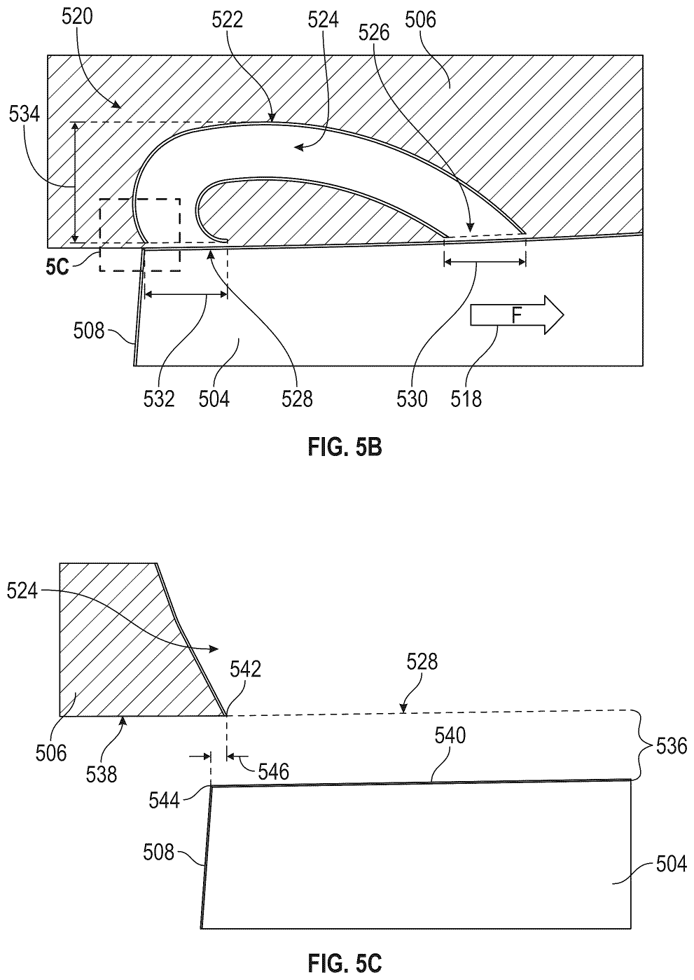

Referring now to FIGS. 5A-5C, schematic illustrations of a portion of a compressor 500 in accordance with an embodiment of the present disclosure are shown. FIG. 5A is a side elevation illustration of the portion of the compressor 500, illustrating a hub 502, a compressor blade 504, and a compressor casing 506. FIG. 5B is an enlarged detailed illustration of the region “5B” labeled in FIG. 5A, and FIG. 5C is an enlarged detailed illustration of the region “5C” labeled in FIG. 5B. The compressor 500 may be similar to that shown and described above. The hub 502 may be provided with any desired number of compressor blades, although only one compressor blade 504 is shown for clarity and for purposes of illustration. The compressor blade 504 may be integrally formed with the hub 502 or may be installed, mounted, or otherwise attached thereto, as will be appreciated by those of skill in the art. The compressor blade 504 extends from a leading edge 508 to a trailing edge 510 and is arranged as an airfoil having a pressure side and a suction side. The leading edge 508 is positioned at or proximate a compressor inlet 512 and the trailing edge 510 is positioned at or proximate a compressor outlet 514. The compressor blade 504 has a leading edge span 516, defined as the length of the compressor blade 504 at the leading edge 508 and in a direction from the hub 502 to the compressor casing 506. The leading edge span 516 is the vertical (radial) dimension of the compressor blade 504 from the hub surface to the blade tip. In some configurations, and as illustrated in FIG. 5A, if the leading edge 508 is angled axially, the length of the leading edge 508 may be longer than the leading edge span 516. The compressor 500 is defined by a number of compressor passages 518 that extend from the compressor inlet 512 to the compressor outlet 514 and are defined between adjacent compressor blades 504 in the circumferential direction.

The compressor casing 506 is provided with a casing treatment 520. The casing treatment 520 of this illustrative embodiment is defined by a single recirculator which is arranged proximate the leading edge 508 of the compressor blade 504. In operation, a main gas path flow is directed into the compressor passage 518 at the compressor inlet 512. The main gas path flow is then rotated and compressed within the compressor 500 by rotation of the compressor blades 504 and the narrowing of the compressor passage 518 from the compressor inlet 512 to the compressor outlet 514. As the compressor blade 504 is rotated, a portion of the main gas path flow within the compressor passage 518, in a space between a tip of the compressor blade 504 and a surface of the compressor casing 506, will be extracted into the recirculator of the casing treatment 520. The extracted flow will enter the recirculator of the casing treatment 520 at a downstream position (i.e., recirculator inlet) and be recirculated back toward the leading edge 508 of the compressor blade 504. The recirculated air will then rejoin with the main gas path flow (i.e., recirculator outlet) upstream from the location it was extracted.

FIG. 5B is an enlarged illustration of the region indicated by the dashed-line box labeled “5B” in FIG. 5A. The enlarged region illustrated in FIG. 5B illustrates details of the casing treatment 520 relative to the compressor blade 504. The casing treatment 520 includes a recirculator 522 defining a recirculator passage 524 that is formed within the material of the compressor casing 506. In other configurations, the casing treatment 520 may be separately formed from the structure of the compressor casing 506 and then installed therein, such as formed as an annular ring that is mounted or attached within an annular channel formed in the compressor casing 506. Accordingly, the specific arrangement and manufacture of the casing treatment is not intended to be limited to a specific or particular configuration.

The recirculator 522 includes a passage inlet 526 and a passage outlet 528. Each of the passage inlet 526 and the passage outlet 528 are openings or include openings that are exposed to the compressor passage 518 to allow for gases (e.g., main gas path flow) to pass through the respective openings to enter or exit the recirculator passage 524. As shown in FIG. 5B, the recirculator 522 has an entry width 530 defined at the passage inlet 526, with the entry width 530 defined in a flow direction F of the main gas path flow through the compressor 500. Similarly, the recirculator 522 has an exit width 532 defined at the passage inlet 526, with the entry width 530 defined in a flow direction F of the main gas path flow through the compressor 500. The recirculatory 522 has a passage height 534, which is defined in a radial direction relative to an axis through the compressor 500 (e.g., axis 302 through the compressor 300 shown in FIGS. 3A-3B).

Referring now to FIG. 5C, an enlarged illustration of the region indicated in the dash-lined box labeled “5C” in FIG. 5B is shown. FIG. 5C illustrates a gap 536 between an inner surface 538 of the compressor casing 506 and a tip 540 of the compressor blade 504. This gap 536 provides the space in which gases may travel or transition from a pressure side to a suction side of the compressor blade 504 (e.g., into/out of the page of FIG. 5C). FIG. 5C illustrates the relationship between a forward end point 542 of the passage outlet 528 and a leading edge end point 544 of the compressor blade 504. The leading edge end point 544 of the compressor blade 504 is defined at the intersection of the leading edge 508 and the tip 540 of the compressor blade 504. The forward end point 542 may be arranged either upstream or downstream relative to the leading edge end point 544 of the compressor blade 504, as described herein, and labeled as offset 546.

In accordance with embodiments of the present disclosure, the features and properties of the casing treatment 520 may be selected to achieve a desired deloading of the inducer region of the compressor blade 504 (e.g., leading edge region and tip region of the blade). In the following discussion of various relationships, the leading edge span 516 is referred to as S_{L}, the entry width 530 is referred to as W_{N}, the exit width 532 is referred to as W_{X}, the passage height 534 is referred to as H_{P}, and the offset 546 at the leading edge 508 is referred to as O_{L}. In the following non-limiting and illustrative discussion, the various relationships may be used individually or in any combination, as will be understood by those of skill in the art.

In accordance with some embodiments, the entry width 530 may be defined as: 0.05 S_{L}≤W_{N}≤0.10 S_{L}; the exit width 532 may be defined as: 0.05 S_{L}≤W_{X}≤0.10 S_{L}; the passage height 534 may be defined as: 0.05 S_{L}≤H_{P}≤0.15S_{L}; and the offset 546 may be defined as: −0.05 S_{L}≤O_{L}≤0.05 S_{L}. As illustrated in FIG. 4, casing treatments in accordance with the present disclosure may include multiple recirculators (or sets of recirculators), which are arranged sequentially in the flow direction F. In such configurations, although the forward most recirculator will have the offset 546 relative to the leading edge 508 of the compressor blade 504, any downstream located recirculators will not be arranged with the offset 546. Rather, the sets of recirculators may be arranged relative to each other.

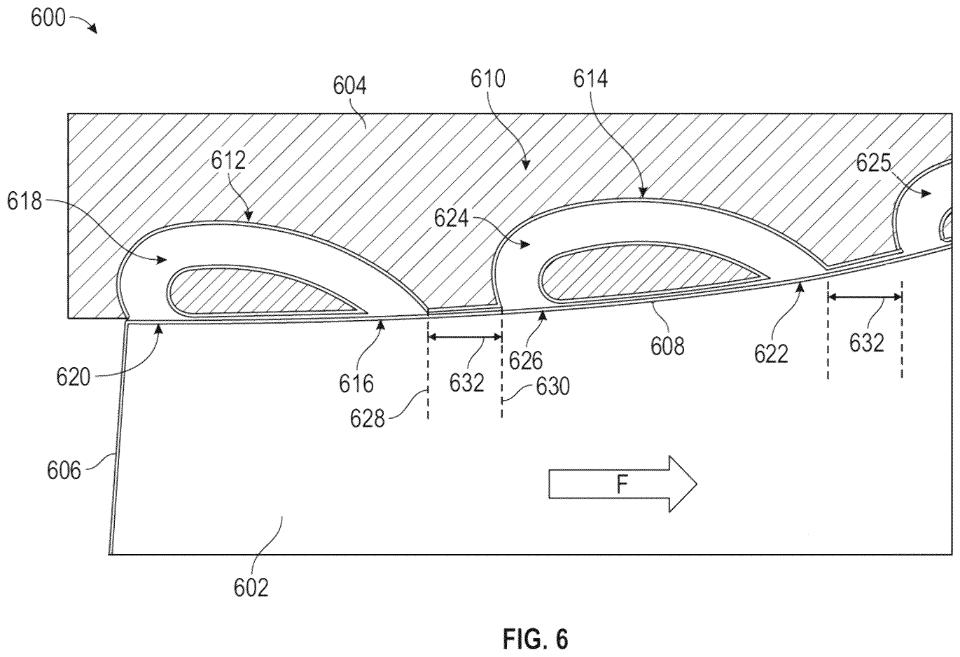

For example, referring now to FIG. 6, a schematic illustration of a portion of a compressor 600 in accordance with an embodiment of the present disclosure is shown. The compressor 600 may be similar to that shown and described above. As shown, a compressor blade 602 is arranged relative to a compressor casing 604. The compressor blade 602 has a leading edge 606 and a blade tip 608. The leading edge 606 is positioned at or proximate a compressor inlet, as shown and described above.

The compressor 600 is provided with a casing treatment 610 having two sets of recirculators 612, 614. The first recirculator 612 is arranged proximate the leading edge 606 of the compressor blade 602 and is an upstream recirculator. The second recirculator 614 is arranged downstream from the first recirculator 612 in a flow direction F of a main gas path flow. The first recirculator 612 has a passage inlet 616, a recirculator passage 618, and a passage outlet 620. The first recirculator 612 is arranged such that a portion of the main gas path flow is enters the passage inlet 616, travels in a counter direction relative to the flow direction F of the main gas path flow through the recirculator passage 618, and is reintroduced into the main gas path flow at the passage outlet 620. Similarly, the second recirculator 614 has a passage inlet 622, a recirculator passage 624, and a passage outlet 626. The second recirculator 614 is arranged such that a portion of the main gas path flow is enters the passage inlet 622, travels in a counter direction relative to the flow direction F of the main gas path flow through the recirculator passage 624, and is reintroduced into the main gas path flow at the passage outlet 626.

Each of the recirculators 612, 614 may be configured similar to that shown and described above. For example, the passage inlets 616, 622 may be sized to according to: 0.05 S_{L}≤W_{N}≤0.10 S_{L}; the passage outlets 618, 626 may be sized according to: 0.05 S_{L}≤W_{X}≤0.10 S_{L}; and the passage height may be configured according to: 0.05 S_{L}≤H_{P}≤0.15S_{L}. However, as noted above, only the first recirculator 612 may be arranged with an offset (relative to the leading edge of the compressor blade 602) according to: −0.05 S_{L}≤O_{L}≤0.05 S_{L}. The position of the second recirculator 614 may be based on the positioning of the first recirculator 612. For example, the first recirculator 612 may be defined as having a respective aft end point 628 and the second recirculator 614 may be defined as having a respective forward end point 630. A recirculator gap 632 is defined between the aft end point 628 of the first recirculator 612 and the forward end point 630 of the second recirculator 614. The recirculator gap 632 (G_{R}) may be defined relative to the span (S_{L}) of the compressor blade 602 along the leading edge 606: 0.05 S_{L}≤G_{R}≤0.10 S_{L}.

Although FIG. 6 illustrates only two recirculators 612, 614, it will be appreciated that additional recirculators may be provided along the compressor passage. That is, compressor casings having casing treatments as described herein, may include any number of recirculators or sets of recirculators arranged in a flow direction. In such configurations, each recirculator may be similarly configured. Furthermore, the spacing of each set of recirculators in the flow direction F may be separated from each other by the recirculator gap, as defined above (e.g., 0.05 S_{L}≤G_{R}≤0.10 S_{L}). In some embodiments, the different recirculators may each satisfy the above relationships relative to the leading edge span of the compressor blade, but the specific dimensions of any given recirculator may be different from the others. For example, recirculators that are arranged farther from the compressor inlet may have smaller passage heights than recirculators that are closer to the compressor inlet. It will be appreciated that other characteristics of the recirculators may also be different from each other. However, in accordance with some embodiments, in a given set of recirculators (e.g., at the same distance from the compressor inlet), each recirculator may be arranged with the same dimensions and characteristics. In still further embodiments, the dimensions and characteristics of the recirculators may be different within a given set, such as in a pattern of different dimensions or the like.

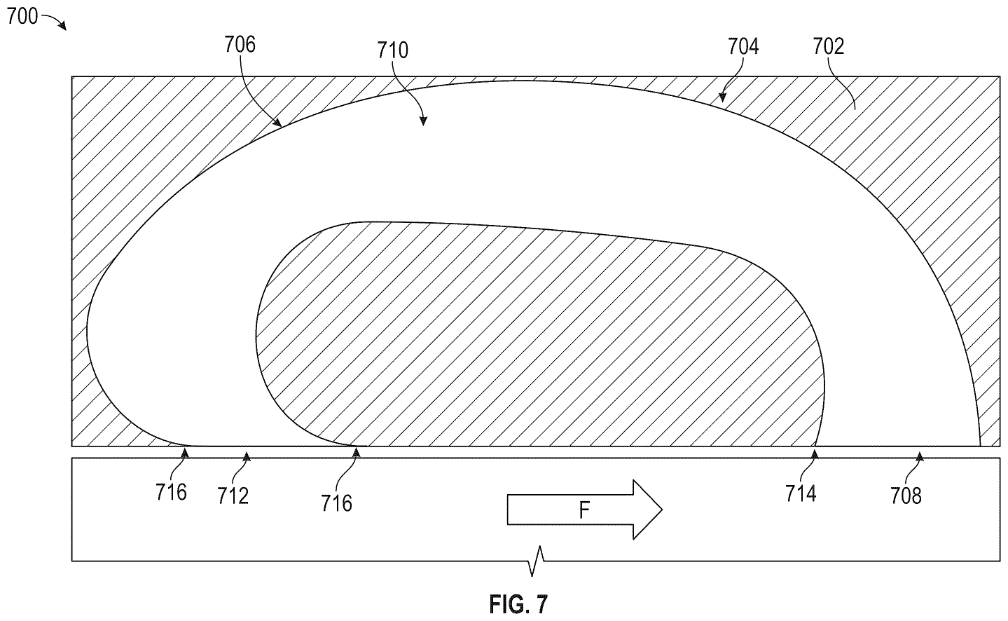

Referring now to FIG. 7, a schematic illustration of a portion of a compressor 700 in accordance with an embodiment of the present disclosure is shown. The compressor 700 may be similar to that shown and described above. As shown, the compressor 700 includes a compressor casing 702 with a casing treatment 704 applied thereto. The casing treatment 704 includes, in this illustration, a single recirculator 706. It will be appreciated that the recirculator 706 may be part of a set of recirculators that are arranged circumferentially about rotating components of the compressor 700, as shown and described above. Additionally, additional recirculators or sets of recirculators may be arranged upstream or downstream relative to the recirculator 706 shown in FIG. 7. The recirculator 706 has a passage inlet 708, a recirculator passage 710, and a passage outlet 712.

As shown in FIG. 7, the passage inlet 708 may be defined with a contoured inlet 714. The contoured inlet 714 defines a scoop or smooth transition zone. The contoured inlet 714 includes a curved surface that is angled toward the compressor inlet. Stated another way, the contoured inlet 714 may be angled in a direction into the main gas path flow (or angled against the flow direction F). The contoured inlet 714 allows for increased efficiency and may provide for relatively close matching with a flow incidency angle as the flow is extracted from the main gas path flow and into the recirculator passage 710. The countered inlet 714 may be provided at the upstream edge of the passage inlet 708. It will be appreciated that complementary contouring may be provided at the downstream edge of the passage inlet 708.

At the passage outlet 712, the recirculator 706 includes a contoured outlet 716. In this illustration, both the upstream edge and the downstream edge of the passage outlet 712 are provided with the features of the contoured outlet 716. The contoured outlet 716 can provide for a smooth, near-tangential re-entry of the recirculated flow. That is, the contoured outlet 716 may be angled in a direction parallel or nearly parallel with the main gas path flow direction F. The contoured outlet 716 may reduce turbulence and improve the mixing of the recirculated flow with the main gas path flow.

It will be appreciated that the passage inlet and passage outlets of the above described embodiments may be configured with contoured inlet features and/or contoured outlet features, as shown and described with respect to FIG. 7. In addition to having contoured inlets/outlet and/or multiple recirculators arranged in a flow direct, the casing treatments of the present disclosure may incorporate alternative configurations.

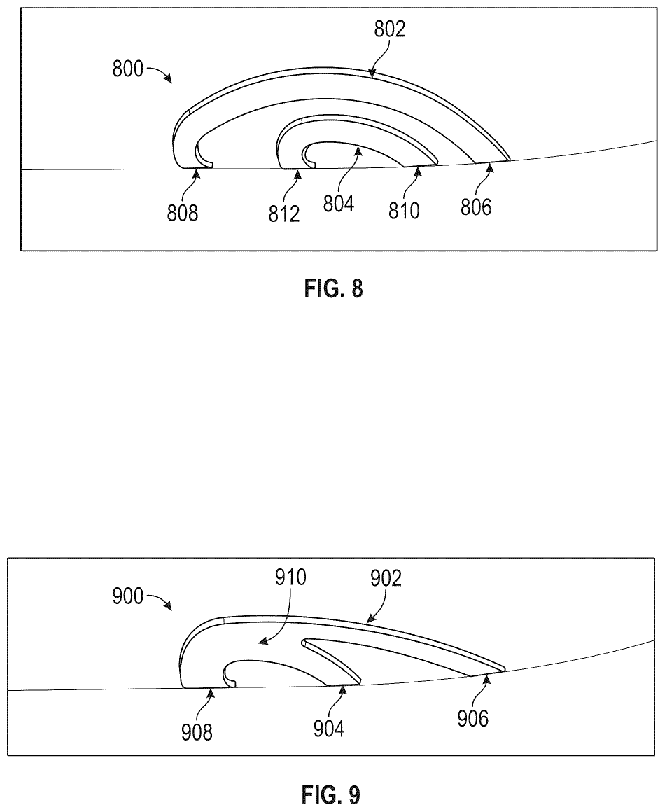

For example, with reference to FIG. 8, a casing treatment 800 in accordance with an embodiment of the present disclosure is shown. The casing treatment 800 may be applied to a compressor casing, similar to that shown and described above. The casing treatment 800 of FIG. 8 includes a first recirculator 802 and a second recirculator 804. In this configuration, a passage inlet 806 of the first recirculator 802 is arranged downstream from the second recirculator 804 and the passage outlet 808 of the first recirculator 802 is arranged upstream from the second recirculator 804. In this configuration, the passage height of the first recirculator 802 is greater than the passage height of the second recirculator 804 such that the second recirculator 804 is arranged within or is enclosed by the first recirculator 802. In accordance with some such embodiments, each of the first recirculator 802 and the second recirculator 804 may be configured with similar flow area widths at the respective inlets, outlets, and/or along the passage from the respective inlet to the respective outlet.

In another configuration, as shown in FIG. 9, a casing treatment 900 includes a single recirculator 902 having two passage inlets 904, 906 and a single passage outlet 908. In this configuration, the recirculator 902 can extract flow from the main gas path flow at both the first passage inlet 904 and the second passage inlet 906. The two passage inlets 904, 906 are fluidly connected to a recirculator chamber 910 where the two flows are joined together prior to being reintroduced into the main gas path flow at the passage outlet 908. In accordance with some such embodiments, the first passage inlet 904 (and related flow passage) and the second passage inlet 906 (and related flow passage) may be arranged with similar flow area widths, and then the flows are merged in the recirculator chamber 910 prior to being reinjected or ejected into the main gas path flow.

In accordance with some embodiments of the present disclosure, the configurations illustrated in FIGS. 8-9, or other geometries, may be configured to satisfy the above described relationships. For example, the passage inlets (806, 810, 904, 906) may each be sized to according to: 0.05 S_{L}≤W_{N}≤0.10 S_{L}; the passage outlets (808, 812, 908) may be sized according to: 0.05 S_{L}≤W_{X}≤0.10 S_{L}; and the passage height may be configured according to: 0.05 S_{L}≤H_{P}≤0.15 S_{L}. For each example configuration, an offset at the leading edge between a forward edge of a passage outlet and the leading edge of a respective compressor blade may be provided according to: −0.05 S_{L}≤O_{L}≤0.05 S_{L}. In the case of the configuration of FIG. 8, and accordingly to some non-limiting embodiments, the passage height of the first recirculator 802 may satisfy the larger end of the noted range, whereas the second recirculator 804 may satisfy the smaller end of the noted range. In configurations similar to that shown in FIG. 9, the two inlets (904, 906) may each individually satisfy the passage inlet width relationship (0.05 S_{L}≤W_{N}≤0.10 S_{L}).

It will be appreciated that the disclosed embodiments, although illustrated and described independently, may have features thereof combined into a configuration not specifically illustrated or described. For example, the multi-channel flow configuration of FIGS. 8-9 may be implemented with multiple recirculators arranged along the flow direction (e.g., FIG. 6). Furthermore, the contoured configuration illustrated in FIG. 7 may be applied to any of the above described embodiments, without departing from the scope of the present disclosure. It will be appreciated that some of these combined configuration may require additive manufacturing capabilities to form the desired geometries.

Advantageously, embodiments of the present disclosure provide for improved performance and increased stall or stability margin for aircraft compressors, resulting in improved engine efficiencies. Traditionally, casing treatment designs are deployed with the intent of increasing compressor stall margin, with an associated decrease in compressor efficiency (or loss in compressor performance). Additionally, prior designs were constrained to the limits of traditional manufacturing methods. Advantageously, embodiments of the present disclosure provide for an increase in stall or stability margin for aircraft compressors, with no distinguishable loss in compressor efficiency or performance. Furthermore, configurations and embodiments described herein are suited for additive manufacturing techniques, allowing for high customization of the geometry, which can result in further efficiency improvements.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. As used herein, the terms “about” and “substantially” are intended to include the degree of error associated with measurement of the particular quantity based upon the equipment available at the time of filing the application. For example, the terms may include a range of ±8%, or 5%, or 2% of a given value or other percentage change as will be appreciated by those of skill in the art for the particular measurement and/or dimensions referred to herein. It should be appreciated that relative positional terms such as “forward,” “aft,” “upper,” “lower,” “above,” “below,” and the like are with reference to normal operational attitude and should not be considered otherwise limiting.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. A centrifugal compressor of a gas turbine engine comprising:
a casing;
a rotor arranged within the casing, the rotor comprising a hub and a plurality of compressor blades extending radially from the hub and rotatable relative to the casing, wherein each compressor blade of the plurality of compressor blades comprises a leading edge arranged at a compressor inlet and a trailing edge arranged at a compressor outlet, wherein a compressor passage is defined from the compressor inlet to the compressor outlet and wherein each compressor blade has a leading edge span (S_{L}) defined as a dimension at the leading edge measured from the hub to a blade tip in a direction toward the casing; and
a casing treatment applied to the casing, wherein the casing treatment comprises a set of recirculators, wherein each recirculator defines a recirculator passage that extends from a passage inlet to a passage outlet, wherein each passage inlet and each passage outlet is fluidly connected to the compressor passage;
wherein a main gas path flow through the compressor passage defines a main flow direction and a recirculation flow through the plurality of recirculators is in a recirculation flow direction, the recirculation flow direction being counter to the main flow direction, and
wherein the passage inlet of each recirculator is at a position downstream relative to a respective passage outlet of the same recirculator in the main flow direction, and
wherein each passage inlet has a dimension in the main flow direction (W_{N}) defined by: 0.05 S_{L}≤W_{N}≤0.10 S_{L}, and wherein each passage outlet has a dimension in the main flow direction (W_{X}) defined by 0.05 S_{L}≤W_{X}≤0.10 S_{L},
wherein each recirculator has a passage height (H_{P}) defined by 0.05 S_{L}≤H_{P}≤0.15S_{L}, wherein the passage height (H_{P}) is a distance from an interior surface of the casing to a maximum radial extent away from the interior surface,
wherein a forward end point of the passage outlet is positioned relative to a leading edge end point of the compressor blades by an offset (O_{L}) defined as −0.05 S_{L}≤O_{L}≤0.05 S_{L}, and
wherein each recirculator has a contoured inlet at the passage inlet, wherein an upstream edge of the passage inlet in the main flow direction is angled in a direction toward the leading edge of the compressor blades.

2-4. (canceled)

5. The centrifugal compressor of claim 1, wherein each recirculator has a contoured outlet at the passage outlet, wherein an upstream edge of the passage outlet in the main flow direction is angled in a direction toward the main flow direction.

6. The centrifugal compressor of claim 1, wherein the set of recirculators defines a first set of recirculators, and wherein the casing treatment comprises a second set of recirculators arranged downstream from the first set of recirculators.

7. The centrifugal compressor of claim 6, wherein the second set of recirculators is separated from the first set of recirculators by a recirculator gap (G_{R}) defined by 0.05 S_{L}≤G_{R}≤0.10 S_{L}.

8. The centrifugal compressor of claim 7, further comprising a third set of recirculators arranged downstream from the second set of recirculators in the main flow direction.

9. The centrifugal compressor of claim 8, wherein the third set of recirculators is separated from the second set of recirculators by the recirculator gap (G_{R}).

10. The centrifugal compressor of claim 1, wherein the set of recirculators defines a first set of recirculators and wherein the casing treatment comprises a second set of recirculators arranged relative to the first set of recirculators such that:
a passage inlet of a recirculator of the second set is arranged upstream of the passage inlet of a recirculator of the first set in the main flow direction; and
a passage outlet of the recirculator of the second set is arranged downstream of the passage outlet of the recirculator of the first set in the main flow direction.

11. The centrifugal compressor of claim 10, wherein a passage height of each recirculator of the first set is greater than a passage height of each recirculator of the second set.

12. The centrifugal compressor of claim 1, wherein the passage inlet of each recirculator is a first passage inlet, wherein each recirculator comprises a second passage inlet arranged downstream from the first passage inlet in the main flow direction.

13. The centrifugal compressor of claim 12, wherein the first passage inlet and the second passage inlet fluidly connect to the passage outlet of each recirculator through the recirculator passage.

14. The centrifugal compressor of claim 13, wherein a flow from the first passage inlet and a flow from the second passage inlet are merged within a recirculator chamber prior to exiting through the passage outlet.

15. The centrifugal compressor of claim 1, wherein a direction of flow out of the compressor outlet is normal to a direction of flow into the compressor inlet.

16. A gas turbine engine comprising:
a fan, a compressor section, a combustor section, and a turbine section arranged along an engine shaft, with a core flow passing through the gas turbine engine in a core flow direction;
wherein the compressor section comprises a centrifugal compressor comprising:
a casing;
a rotor arranged within the casing, the rotor comprising a hub and a plurality of compressor blades extending radially from the hub and rotatable relative to the casing, wherein each compressor blade of the plurality of compressor blades comprises a leading edge arranged at a compressor inlet and a trailing edge arranged at a compressor outlet, wherein a compressor passage is defined from the compressor inlet to the compressor outlet and wherein each compressor blade has a leading edge span (S_{L}) defined as a dimension at the leading edge measured from the hub to a blade tip in a direction toward the casing; and
a casing treatment applied to the casing, wherein the casing treatment comprises a set of recirculators, wherein each recirculator defines a recirculator passage that extends from a passage inlet to a passage outlet, wherein each passage inlet and each passage outlet is fluidly connected to the compressor passage;
wherein a main gas path flow through the compressor passage defines a main flow direction and a recirculation flow through the plurality of recirculators is in a recirculation flow direction, the recirculation flow direction being counter to the main flow direction, and
wherein the passage inlet of each recirculator is at a position downstream relative to a respective passage outlet of the same recirculator in the main flow direction, and
wherein each passage inlet has a dimension in the main flow direction (W_{N}) defined by: 0.05 S_{L}≤W_{N}≤0.10 S_{L}, and wherein each passage outlet has a dimension in the main flow direction (W_{X}) defined by 0.05 S_{L}≤W_{X}≤0.10 S_{L},
wherein each recirculator has a passage height (H_{P}) defined by 0.05 S_{L}≤H_{P}≤0.15S_{L}, wherein the passage height (H_{P}) is a distance from an interior surface of the casing to a maximum radial extent away from the interior surface,
wherein a forward end point of the passage outlet is positioned relative to a leading edge end point of the compressor blades by an offset (O_{L}) defined as −0.05 S_{L}≤O_{L}≤0.05 S_{L}, and
wherein each recirculator has a contoured inlet at the passage inlet, wherein an upstream edge of the passage inlet in the main flow direction is angled in a direction toward the leading edge of the compressor blades.

17. The gas turbine engine of claim 16, wherein each recirculator has a contoured outlet at the passage outlet wherein an upstream edge of the passage outlet is angled in a direction toward the main flow direction.

18. The gas turbine engine of claim 16, wherein a direction of flow out of the compressor exit is normal to a direction of flow into the compressor inlet.

19. The gas turbine engine of claim 16, wherein the set of recirculators defines a first set of recirculators, and wherein the casing treatment comprises a second set of recirculators arranged downstream from the first set of recirculators.

20. The gas turbine engine of claim 19, wherein the second set of recirculators is separated from the first set of recirculators by a recirculator gap (G_{R}) defined by 0.05 S_{L}≤G_{R}≤0.10 S_{L}.

21. The gas turbine engine of claim 19, further comprising a third set of recirculators arranged downstream from the second set of recirculators in the main flow direction.

22. The gas turbine engine of claim 16, wherein the set of recirculators defines a first set of recirculators and wherein the casing treatment comprises a second set of recirculators arranged relative to the first set of recirculators such that:
a passage inlet of a recirculator of the second set is arranged upstream of the passage inlet of a recirculator of the first set in the main flow direction; and
a passage outlet of the recirculator of the second set is arranged downstream of the passage outlet of the recirculator of the first set in the main flow direction.

23. The gas turbine engine of claim 16, wherein the passage inlet of each recirculator is a first passage inlet, wherein each recirculator comprises a second passage inlet arranged downstream from the first passage inlet in the main flow direction.
